(19) United States
(12) Patent Application Publication
(10) Pub. No.: US 2020/0039406 A1
(43) Pub. Date: Feb. 6, 2020

(54) HEADREST

(71) Applicants: Ralph Nuss, Poppenricht (DE); Gerhard Delling, Schmidgaden (DE); Erwin Himmelhuber, Sulzbach (DE); Manuel Boesl, Freudenberg (DE); Hubert Keller, Kuemmersbruck (DE)

(72) Inventors: Ralph Nuss, Poppenricht (DE); Gerhard Delling, Schmidgaden (DE); Erwin Himmelhuber, Sulzbach (DE); Manuel Boesl, Freudenberg (DE); Hubert Keller, Kuemmersbruck (DE)

(21) Appl. No.: 16/458,620

(22) Filed: Jul. 1, 2019

(30) Foreign Application Priority Data
Jul. 5, 2018 (DE) 102018005316.5

(51) Int. Cl. B60N 2/847; B60N 2/865

(52) U.S. Cl. CPC B60N 2/847; B60N 2/865

(57) ABSTRACT

A headrest has a mount fixable on a vehicle seat, a head support, first and second links each having one end pivoted on the mount and an opposite end pivoted on the head support for movement of the head support relative to the mount forward toward a head of a user in the seat and rearward away from the head of the user. First latch formations on the links and second latch formations fittable with the first latch formations and either on the head support or on the mount are movable between a latching position engaged with each other to arrest pivoting of the links and forward and rearward movement of the headrest relative to the mount, and a release position disengaging the first and second latch formations from each other to permit such pivoting and movement.

The invention relates to a headrest.

The object was achieved by a headrest having the features of claim 1.

A headrest of this type is known from DE 10 2010 007 942 A1. The headrest comprises a retaining plate, which is attached to the backrest of a vehicle seat. Two parallel upper and lower struts, which are pivotably connected to a head support part, are hinged on the retaining plate. In this way, the head support part can be moved between a rearward and a forward position. The upper struts are provided with a tooth system, which can be releasably engaged with a pivotable latch in order to lock the head support part in the set position.

The object of the present invention was to create a headrest having a narrow construction in a side view. Furthermore, the object of the present invention was to equip the headrest with a functionally reliable latching device with which the head support part can be securely locked in the set position.

The headrest according to the invention comprises a head support part, which can be mounted on a structure of a vehicle using a support device. The term ‘support device’ within the meaning of the invention refers to all devices that are suitable for attaching to the structure. All parts that are indirectly connected to the structure also constitute the structure of the vehicle within the meaning of the invention, e.g. vehicle seat, vehicle console, wall or floor of the vehicle.

The head support part can be moved forwards relative to the support device towards the head of a user and back in the opposite direction using an adjusting device. This movement does not have to be a rectilinear movement in the X-plane; the movement can comprise only portions of such a movement.

The adjusting device comprises at least a first link and a second link, wherein each link forms at least one hinge with the head support part and with the support device. The wording “forms a hinge with the head support part” should be construed within the meaning of the invention as indicating that the hinge can also be formed with a part that is connected to the head support part, such as e.g. a bearing part on which the head support part is immovably or movably retained. At least two links are arranged one behind the other in the x-direction.

The adjusting device comprises a latching device with which a relative movement between the support device and the head support part can be releasably blocked. The latching device can be moved between a locked position, in which a relative movement between the support device and the head support part is blocked in at least one direction, and a release position in which the relative movement is possible.

The latching device comprises first latching means, which are retained on at least one link, and second latching means, which are assigned to the head support part or the support device, wherein the latching means are releasably engageable. The latching means do not have to be attached directly to the link or the head support part. They can also be arranged on parts that are connected to the head support part or the link, as appropriate. In the locked position the first latching means and the second latching means are engaged, and in the release position the latching means are disengaged.

The first latching means have e.g. positively locking means, in particular in the form of a tooth system, and the second latching means have complementary positively locking means. As a result of the interacting positively locking means, a relative movement between the head support part and the link or between the support device and the link is prevented. With the positively locking means, a functionally reliable movement of the latching device between the locked position and the release position and secure locking are made possible.

The first latching means are configured e.g. at an end region of the link. The end region of the link can face towards the support device or alternatively can face away from the support device, i.e. towards the head support part. In the event of a blocking of the relative movement of the head support part and at least one link, the first latching means face away from the support device, for example. In this case, there is no large gap to be overcome between the end region of the link and the head support part. The first latching means and/or the second latching means are configured e.g. on a circular path.

The second latching means are assigned e.g. to at least one movable latch, which is retained movably between the locked position and the release position on the head support part or on the support device. The movement path of the latch is different from the movement path of the head support part, for example. The movement path of the latch is oriented e.g. transverse to the movement path of the head support part. While the movement of the head support part takes place in the x-direction, the movement of the latch can take place in the y-direction, for example.

The first link and the second link have e.g. arms that are arranged parallel to one another. Between the parallel arms a gap is formed. Each link comprises e.g. two arms, which can be moved in parallel planes, the planes extending in the x-direction.

The parallel arms according to one embodiment are connected together by a crosspiece. In this way, greater stability is achieved by stiffening. Alternatively, the parallel arms can also be movably connected only by the part with which they form a hinge, i.e. with the support device or the head support part.

Each arm forms a hinge with the head support part and a hinge with the support device, for example.

Two exemplary embodiments of the invention are described by way of example in the following description of the figures, with reference also to the schematic drawings. For the sake of clarity here—including where different exemplary embodiments are concerned—identical or comparable parts or elements or regions are referred to by the same reference signs, with the addition of lower case letters in some cases.

Features that are presented or disclosed with reference to only one exemplary embodiment can also be provided within the framework of the invention in any other exemplary embodiment of the invention. Exemplary embodiments modified in this way are also covered by the invention, even if they are not shown in the drawings.

All disclosed features are in themselves essential to the invention. The disclosure content of the cited documents and of the described prior art devices is hereby also incorporated in the disclosure of the application in full in terms of content, including for the purpose of taking up individual or multiple features of the subject-matters disclosed there in one or more claims of the present application. Such modified exemplary embodiments are also covered by the invention, even if they are not shown in the drawings.

The figures show the following:

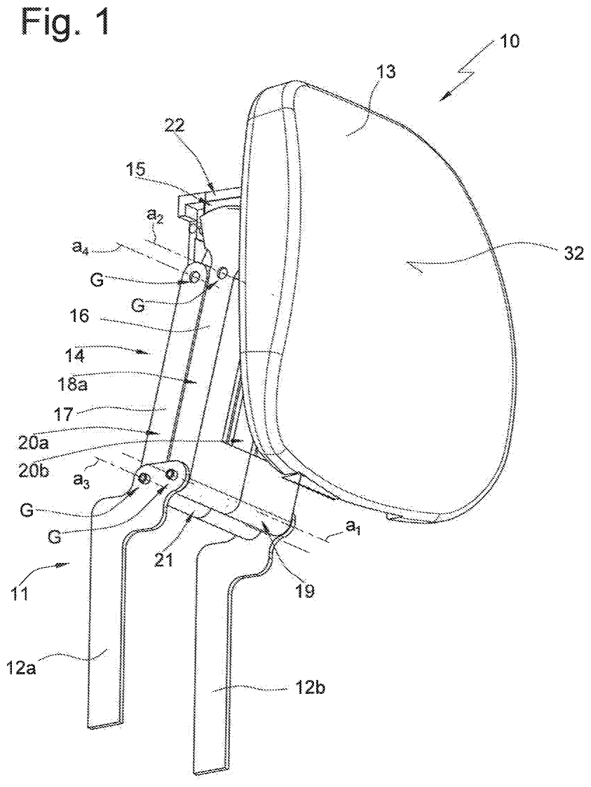

FIG. 1 shows a perspective view of a first exemplary embodiment of the headrest according to the invention obliquely from the front, wherein the head support part is arranged in a forward position,

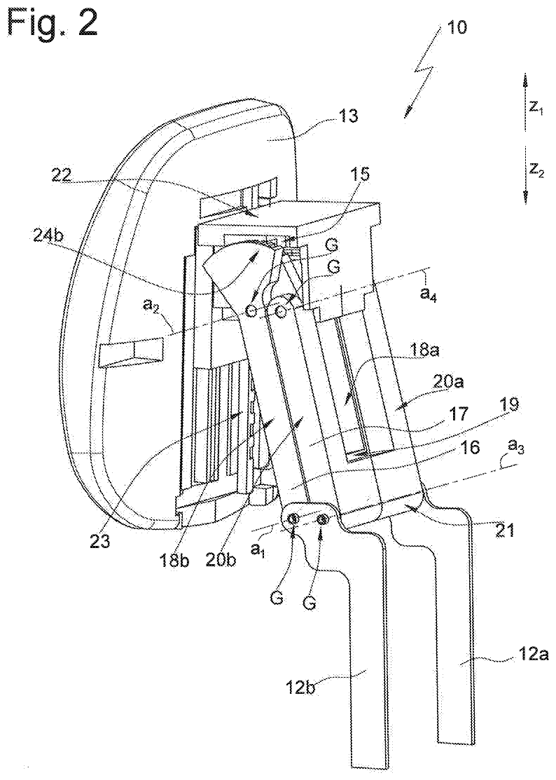

FIG. 2 shows a perspective view of the headrest according to FIG. 1 obliquely from the back,

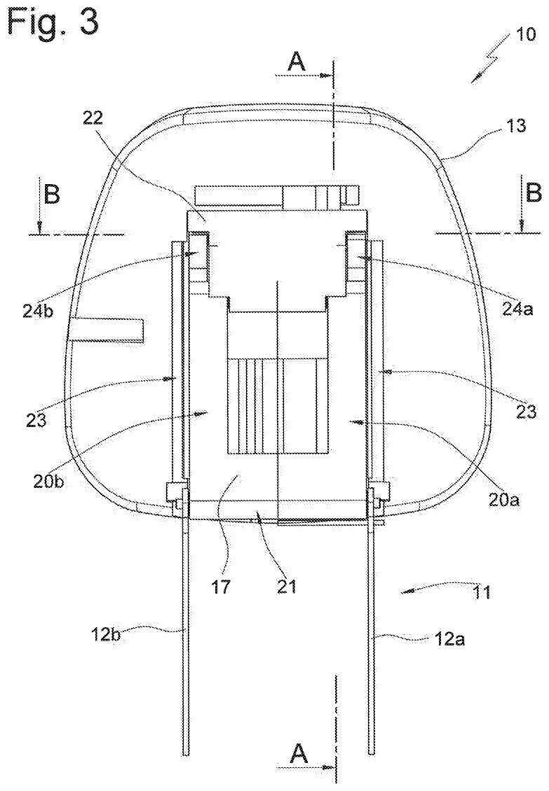

FIG. 3 shows a back view of the headrest,

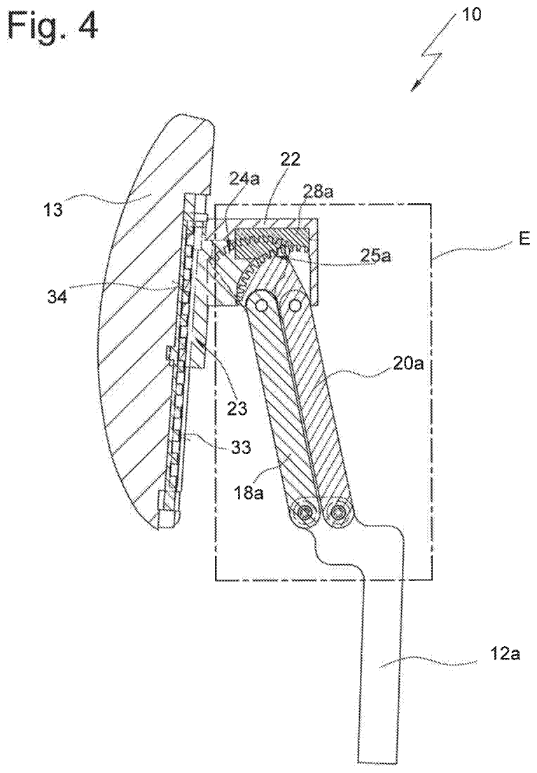

FIG. 4 shows a sectional view of the headrest according to section line A-A in FIG. 3,

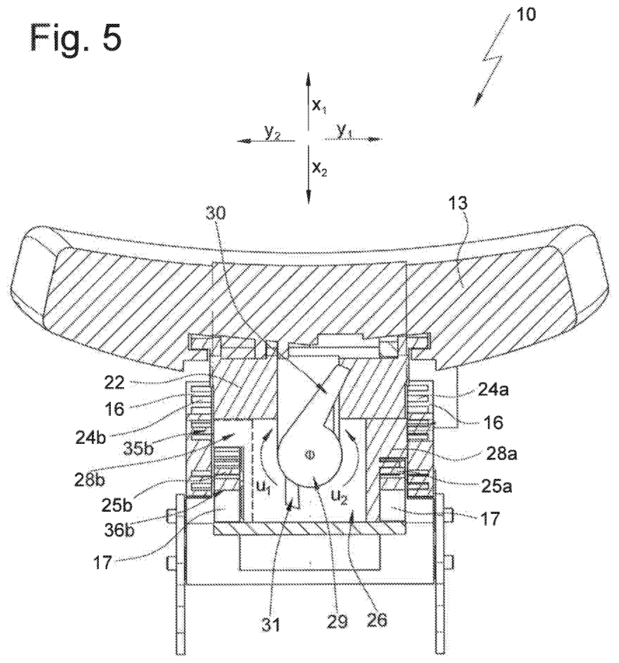

FIG. 5 shows a sectional view according to section line B-B in FIG. 3,

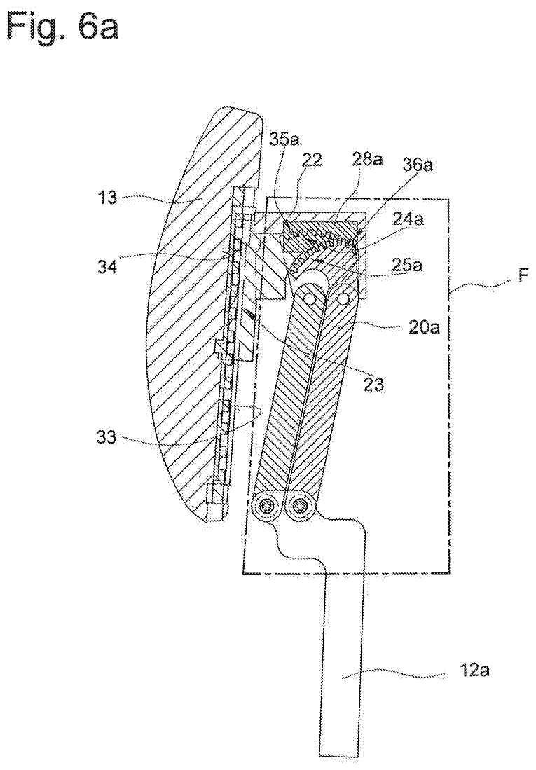

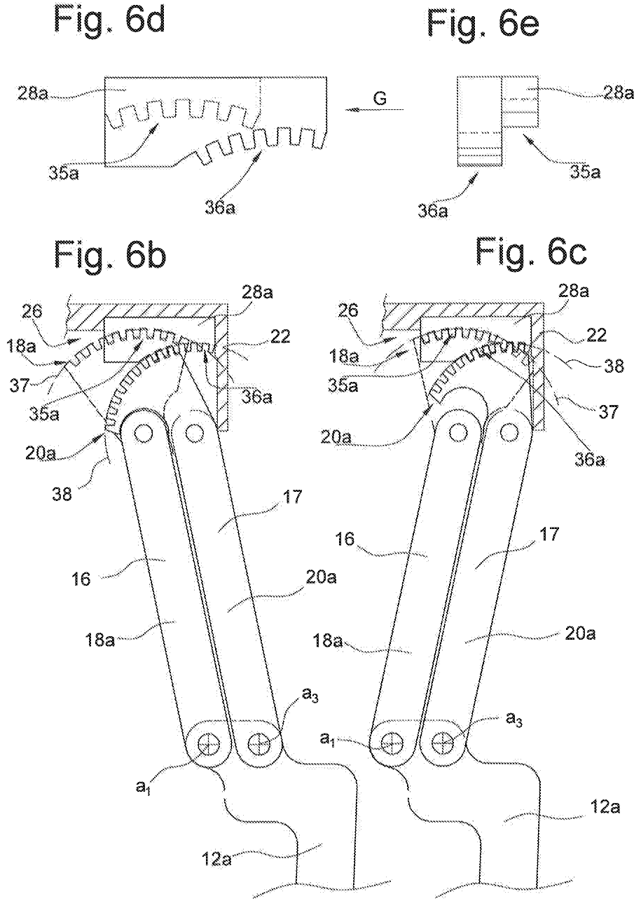

FIG. 6a shows a sectional view based on FIG. 4, wherein the head support part is arranged in a rearward position,

FIG. 6b shows a cut-out illustration according to cut-out line E in FIG. 4, wherein regions of the bearing part are not illustrated for the sake of clarity,

FIG. 6c shows a cut-out illustration according to cut-out line F in FIG. 6a, wherein regions of the bearing part are not illustrated for the sake of clarity,

FIG. 6d shows an individual part illustration of the latch 28a,

FIG. 6e shows a view according to arrow G in FIG. 6d,

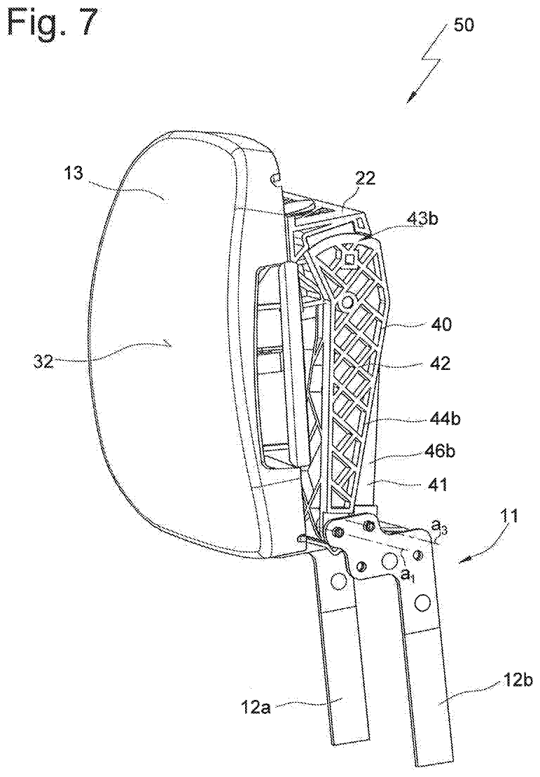

FIG. 7 shows a perspective view of a second exemplary embodiment of the headrest according to the invention obliquely from the front, wherein the head support part is arranged in a rearward position,

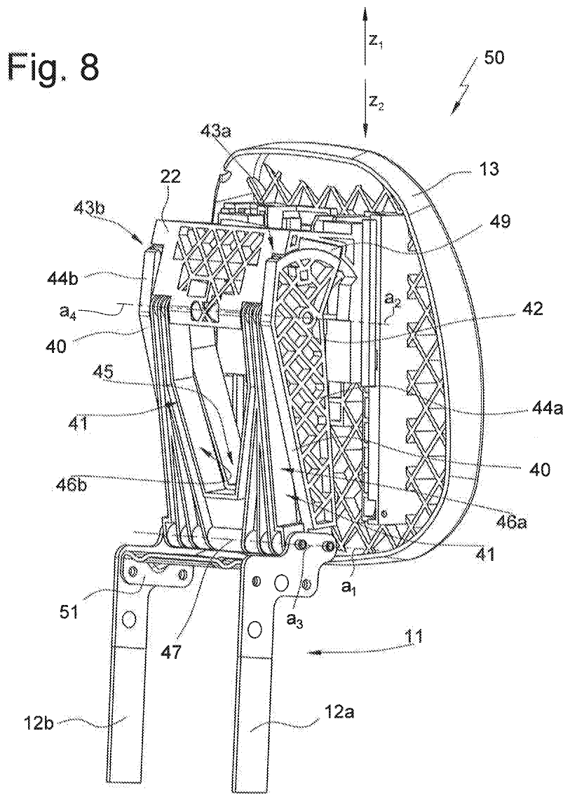

FIG. 8 shows a perspective view of the headrest according to FIG. 7 obliquely from the back,

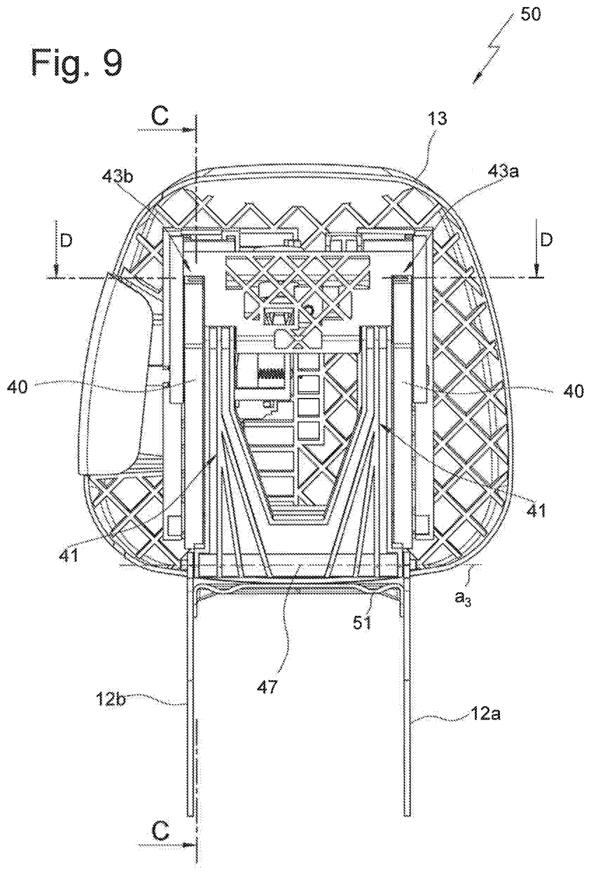

FIG. 9 shows a back view of the headrest,

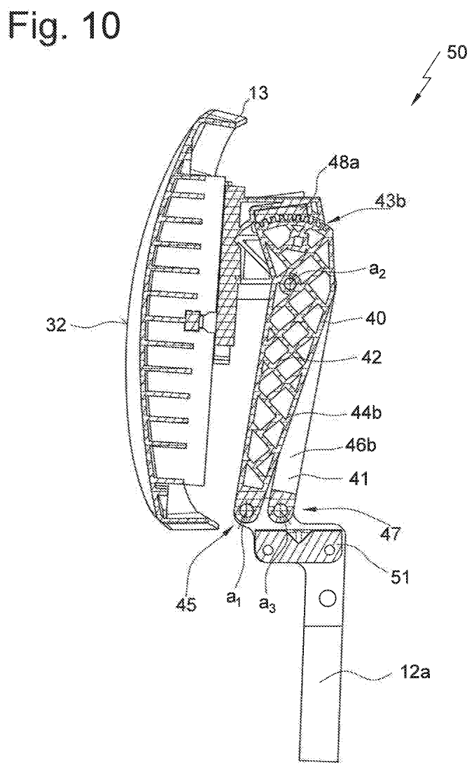

FIG. 10 shows a sectional view of the headrest according to section line C-C in FIG. 9,

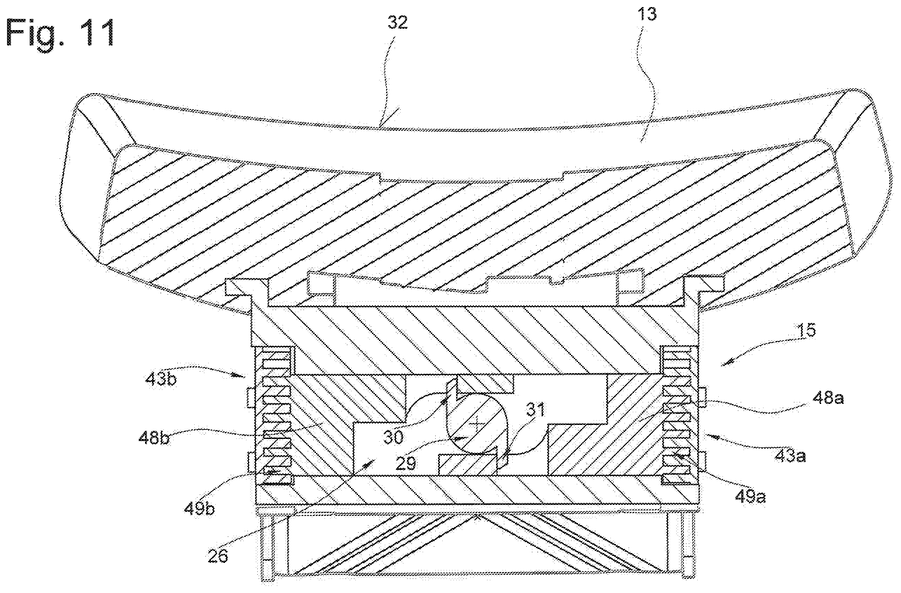

FIG. 11 shows a sectional view according to section line D-D in FIG. 9, wherein the latching device is in the locked position,

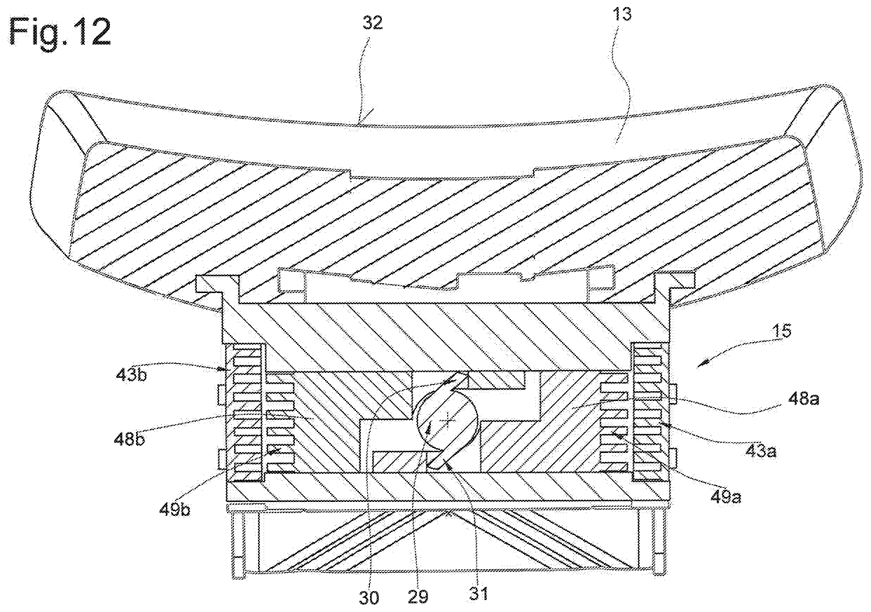

FIG. 12 shows a sectional view based on FIG. 11, wherein the latching device is arranged in a release position, and

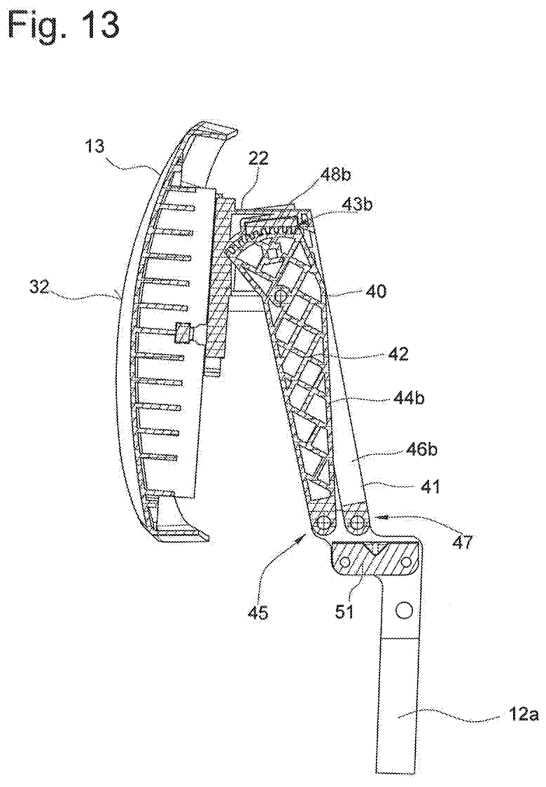

FIG. 13 shows a sectional view based on FIG. 10, wherein the head support part is arranged in a forward position.

A headrest according to a first exemplary embodiment is referred to overall by the reference number 10 in FIGS. 1 to 6.

The headrest comprises a support device 11, which in the present exemplary embodiment comprises support bars 12a and 12b. Instead of the support bars 12a and 12b, the support device could alternatively also have a support bar bracket. In the present exemplary embodiment, the support device 11 can be attached in a conventional manner to the structure of a backrest. Furthermore, the headrest 10 comprises a head support part 13 with a head support surface 32, which is mounted on the support device 11 with an adjusting device 14 in such a way that it can be moved between a forward position as illustrated in FIGS. 1 to 4 and a rearward position as illustrated in FIG. 6a.

By means of a latching device 15 (see FIG. 2), the head support part can be locked in different positions.

The adjusting device 14 comprises a first link 16 and a second link 17 one behind the other in the x-direction. The link 16 has a U-shaped construction and comprises arms 18a and 18b and a crosspiece 19 connecting the arms 18a and 18b. In the same way, the link 17 has a U-shaped construction. It comprises arms 20a and 20b and a crosspiece 21, which connects the arms 20a and 20b. As an alternative to this embodiment, it is possible for the arms 18a and 18b and the arms 20a and 20b not to be connected to each other by a crosspiece. However, greater stability is achieved with the crosspieces 19 and 21.

At a lower end region that is formed by the crosspiece 19, the first link 16 forms a hinge G with each of the support bars 12a and 12b, such that the first link 16 can be pivoted around a pivot axis a₁ relative to the support bars 12a and 12b. At an upper end region, each arm 18a and 18b forms a hinge G with a bearing part 22, on which the head support part 13 is retained in a height-adjustable manner. In this way, the bearing part 22 can be pivoted around a pivot axis a₂ relative to the first link 16.

In the same way, at a lower end region that is formed by the crosspiece 21, the second link 17 forms hinges G with the support bars 12a and 12b so that a pivot axis “amtstartA₃ is formed. In an upper end region of the link 17, each arm 20a and 20b forms a hinge G with the bearing part 22, wherein the hinges G define a pivot axis a₄. In this way, the fixedly arranged support bars 12a and 12b, the links 16 and 17 and the bearing part 22 form a coupling gear. The head support part 13 is thus mounted on the support device 11 movably along a coupling curve, wherein a movement takes place in the directions x₁ or x₂ and a movement takes place in the directions z1 or z2.

At an upper end region facing away from the support device 11 the arm 18a of the first link 16 has latching means 24a and the arm 18b has latching means 24b (see FIGS. 4 and 5). These are configured in the form of a tooth system, which extends along a circular path around the pivot axis a₂. The tip circle of the circular path of the latching means 24a is labelled as 37 in FIGS. 6c and 6d. In the same way, at an upper end region, the arm 20a of the second link 17 has latching means 25a and the arm 20b has latching means 25b, which take the form of a tooth system that extends along a circular path around the pivot axis a₄. The tip circle of the circular path of the latching means 25a is labelled as 38 in FIGS. 6c and 6d.

In an accommodating space 26 of the bearing part 22, a latch 28a and a latch 28b are movably accommodated. (The latch 28b is only indicated by a broken line in FIG. 5.) The latch 28a has latching means 35a and 36a, which interact with the latching means 24a and 25a. The latch 28b has latching means 35b and 36b, which interact with the latching means 24b and 25b. The latch 28a can in this way be moved to engage releasably with the latching means 24a and 25a of the links 16 and 17. In the same way, the latch 28b can be moved to engage releasably with the latching means 24b and 25b.

When the latching device 15 is in a locked position, i.e. when the latching means 35a and 36a are engaged with the latching means 24a and 25a and the latching means 35b and 36b are engaged with the latching means 24b and 25b, the links 16 and 17 cannot turn around the axes a₂ and a₄ relative to the bearing part 22, i.e. a movement of the head support part 13 is blocked in at least one direction.

In a release position of the latching device 15, the latching means of the latches 27 and 28 are disengaged from the latching means of the links 16 and 17, i.e. the adjusting device 14 is freely movable and the head support part 13 can be moved between the forward and the rearward positions in the directions x₁ and x₂. The release position is not shown in FIGS. 1 to 6.

The actuation of the latching device 15 is not shown. For example, a switch can be provided on the head support part 13, on the bearing part 22 or at any other place, wherein the movement of the switch is transferred to a movement of the latches 27 and 28 by means of a transfer device. The movement of the latches 27 and 28 takes place in the present exemplary embodiment by way of a lever 29 (see FIG. 5), which is part of such a transfer device. The lever 29 is mounted on the bearing part 22 pivotably around a pivot axis a5. The lever 29 has arms 30 and 31, wherein the arm 30 is in contact with the latch 28a and the arm 31 is in contact with the latch 28b. If the lever 29 pivots clockwise in the direction u1 according to FIG. 6, the latch 28b is moved in the direction y₁ and the latch 28a in the direction y₂ into the release position.

The latches 27 and 28 are spring-loaded in such a way that, during the movement into the release position, spring energy is built up which loads the latches 28a and 28b back into the locked position. When the lever 29 is unloaded, the latches 28a and 28b are therefore automatically moved back into the locked position according to FIG. 5.

For the sake of completeness, it should also be mentioned that the head support part 13 is guided height-adjustably in the directions z1 and z2 on the bearing part 22 and can be locked in various height positions with a locking device 23. The locking device 23 comprises locking means 33 assigned to the head support part 13 and locking means 34 assigned to the bearing part 22.

In a second exemplary embodiment of a headrest 50, illustrated in FIGS. 7 to 13, the adjusting device 14 has a first link 40 and a second link 41, which differ from the links 16 and 17 by the fact that the links 40 and 41 are made of plastic. As can be seen in FIG. 7, the first link 40 is larger and is provided with ribs 42, which have a stabilizing purpose.

In addition, the second exemplary embodiment differs from the first exemplary embodiment by the fact that only the first link 40 is provided [with] latching means 43a and 43b in the form of a tooth system. Despite their different shape, the links 40 and 41 also have a U shape. The link 40 is formed with arms 44a and 44b and with a crosspiece 45 connecting the arms 44a and 44b. The link 41 has arms 46a and 46b and a crosspiece 47 connecting the arms 46a and 46b. Furthermore, the support bars 12a and 12b are connected together by a connecting piece 51.

The latching means 43a are arranged at an upper end region of the arm 44a facing away from the support device 11, and the latching means 43b are arranged at an upper end region of the arm 44b of the link 40. According to FIG. 11, the latching device 15 has two latches 48a and 48b, which are arranged in the accommodating space 26 and can be moved in the directions y₁ and y₂. In the locked position, latching means 49a of the latch 48a engage with the latching means 43a, and latching means 49b of the latch 48b engage with the latching means 43b.

In the event of a clockwise movement of the lever 29 in the direction u1 according to FIG. 11, the latch 48a is moved against the restoring force in the direction y₁ and the latch 48b is moved against the restoring force in the direction y₂. The latching device 15 is then in the release position according to FIG. 12. When the latch 29 is unloaded, the latch 48a is moved back in the direction y₂ and the latch 48b in the direction y₁ into the locked position.

In the other features, the second exemplary embodiment substantially matches the first exemplary embodiment.

1. A headrest comprising:
a head support mountable on a vehicle seat by a mount and movable forward relative to the mount toward a head of a user and back in the opposite direction by an adjusting device having at least one first link and a second link, each link forming at least one pivot with the head support and with the mount, relative movement between the mount and the head support being releasably blocked by a latch having first latch formations formed by on at least one link and second latch formations on the head support or the mount, the first latch formations and the second latch formations being releasably engageable.

2. The headrest according to claim 1, wherein the first latch formations comprise teeth, and the second latch formations are complementary to the teeth.

3. The headrest according to claim 2, wherein the first latch formations are formed at an upper end region of the one link.

4. The headrest according to claim 1, wherein the second latch formations are on at least one movable latch, movable between a locked position and a release position on the head support or on the mount.

5. The headrest according to claim 1, wherein in a movement direction the first link and the second link each have two arms parallel to each other and forming a gap between the parallel arms.

6. The headrest according to claim 5, wherein the parallel arms are connected together by a crosspiece.

7. The headrest according to claim 5, wherein each arm forms a pivot with the head support and a pivot with the mount.

8. The headrest according to claim 1, wherein the mount forms a four-bar linkage with the links and the head support.

9. The headrest according to claim 1, wherein each link forms at least one pivot with the mount and a pivot with a bearing part of the head mount on which the head support is mounted.

10. The headrest according to wherein the latch is movably accommodated in an accommodating space, which is configured on the head mount.

11. A headrest comprising:
a mount fixable on a vehicle seat;
a head support;
first and second links each having one end pivoted on the mount and an opposite end pivoted on the head support for movement of the head support relative to the mount forward toward a head of a user in the seat and rearward away from the head of the user;
first latch formations on the links;
second latch formations fittable with the first latch formations and either on the head support or on the mount; and
latch means for engaging the first and second latch formations with each other to arrest pivoting of the links and forward and rearward movement of the headrest relative to the mount, and for disengaging the first and second latch formations from each other to permit such pivoting and movement.
